(19) United States
(12) Patent Application Publication
(10) Pub. No.: US 2009/0178101 A1
(43) Pub. Date: Jul. 9, 2009

(54) METHOD AND DEVICE FOR SELECTING AMONG ALTERNATIVE DATA ITEMS

(75) Inventors: Deepak Pai, Bangalore (IN); Sanjay Bhat, Bangalore (IN); Anantharaman Rama Moorthy, Bangalore (IN); Padma Lakshmi Anoop Kulkarni, Bangalore (IN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/305,204

(22) PCT Filed: Jun. 15, 2007
(86) PCT No.: PCT/IB07/52283

§ 371 Date: Dec. 17, 2008

(30) Foreign Application Priority Data
Jun. 20, 2006 (EP) 06115713.7

(51) Int. Cl. H04N 7/16; G06F 17/00; H04N 5/445

(52) U.S. Cl. 725/151; 715/234; 725/39

(57) ABSTRACT

The method of selecting a data item of the invention comprises the steps of receiving a first data item (35) of a first type, e.g. a short program description, and selecting the first data item (35), e.g. for display. The method further comprises selecting a second data item (37) of a second type, e.g. a long program description, instead of the first data item (35) of the first type upon receiving the second data item (37) and not selecting the first data item (35) again upon receiving the first data item (35) again. The electronic device of the invention comprises electronic circuitry configured to perform the method of the invention. The computer program product of the invention comprises software for enabling a programmable device to perform the method of the invention.

The invention relates to an electronic device comprising electronic circuitry, the electronic circuitry being configured to receive and select a first data item of a first type, e.g. a short program description.

The invention further relates to a method of selecting a data item which comprises the steps of receiving and selecting a first data item of a first type.

The invention also relates to a computer program product comprising software for enabling a programmable device to perform a method of selecting a data item.

An example of such a method is known from Philips™ televisions that comply with the DVB standard and process DVB-SI data. These Philips™ televisions display the content of the DVB-SI short info field of a certain program when the corresponding program listing is highlighted and the info button is pressed. A drawback of the known method is that only the content of the short info field is shown, because the content of the extended info field is often not yet available when a user presses the info button and not presenting a program description when requested by the user is not appreciated by the user.

It is a first object of the invention to provide an electronic device of the type described in the opening paragraph, which can select among alternative data items to allow a more user-friendly presentation of data.

It is a second object of the invention to provide a method of the type described in the opening paragraph, which can select among alternative data items to allow a more user-friendly presentation of data.

According to the invention, the first object is realized in that the electronic circuitry is further configured to select a second data item of a second type instead of the first data item of the first type upon receiving the second data item and not select the first data item again upon receiving the first data item again. This ensures that if one of the alternative data items is available, this alternative data item is selected, but if at least two alternative data items are available, only one of the at least two alternative data items, the preferred one, is selected.

In an embodiment of the electronic device of the invention, the electronic circuitry is configured to parse documents, e.g. XML documents, the first type corresponding to a first document tag and the second type corresponding to a second document tag. Alternatively, the electronic circuitry may be configured to parse data structures. Each data type may have its own start position and end position in the data structure. However, the use of documents instead of data structures provides more flexibility.

The electronic circuitry may be configured to repeatedly receive the first data item at a first interval and receive the second data item at a second interval, the second interval being longer than the first interval. This is for example the case when receiving DVB-SI data, where the short description is transmitted more often than the long description. Although the long description may be preferred, the short description can be selected when the long description is unavailable and can be replaced by the long description as soon as the long description is received. Alternatively, the first data item and the second item may be received only once, e.g. over the Internet. The first data item could be available a certain period before the second data item. For example, EPG data from a certain data source may comprise short descriptions for two weeks and long descriptions for one week or EPG data from a first source may comprise short descriptions for two weeks and EPG data from a second source may comprise long descriptions for one week.

The electronic circuitry may be configured to first display the first data item of the first type and display the second data item instead of the already displayed first data item upon reception of the second data item. This is especially advantageous when the second data item does not take long to arrive, but too long to wait for it to arrive, i.e. to select no data item in the mean time. Alternatively, the second data item is only displayed the next time one of the alternative data items needs to be selected, e.g. when a user requests information about an item to which the first and second data items are associated. When the second data item is received, it may immediately be displayed in addition to a displayed first data item and displayed instead of the first data item the next time one of the alternative data items needs to be selected.

The first type and the second type may be user-definable. This allows the user to define which of the alternative data types he prefers, e.g. a long description or a short description.

The first type may represent a short description (e.g. 2 or 3 lines) and the second type may represent a long description (e.g. 10 lines). The electronic device is especially advantageous in this case, because there is usually overlap between the short and the long description and it is therefore not user-friendly to combine both descriptions.

The short description and the long description may describe a broadcast program. Short descriptions and long description are often used in electronic program guides (EPGs). Alternatively, the short and the long description could describe a news items or the first and second types could represent other attributes of a news item.

According to the invention, the second object is realized in that the method further comprises the step of selecting a second data item of a second type instead of the first data item of the first type upon receiving the second data item and not selecting the first data item again upon receiving the first data item again. The method may be performed by a computer program or an Internet EPG, for example.

These and other aspects of the invention are apparent from and will be further elucidated, by way of example, with reference to the drawings, in which:

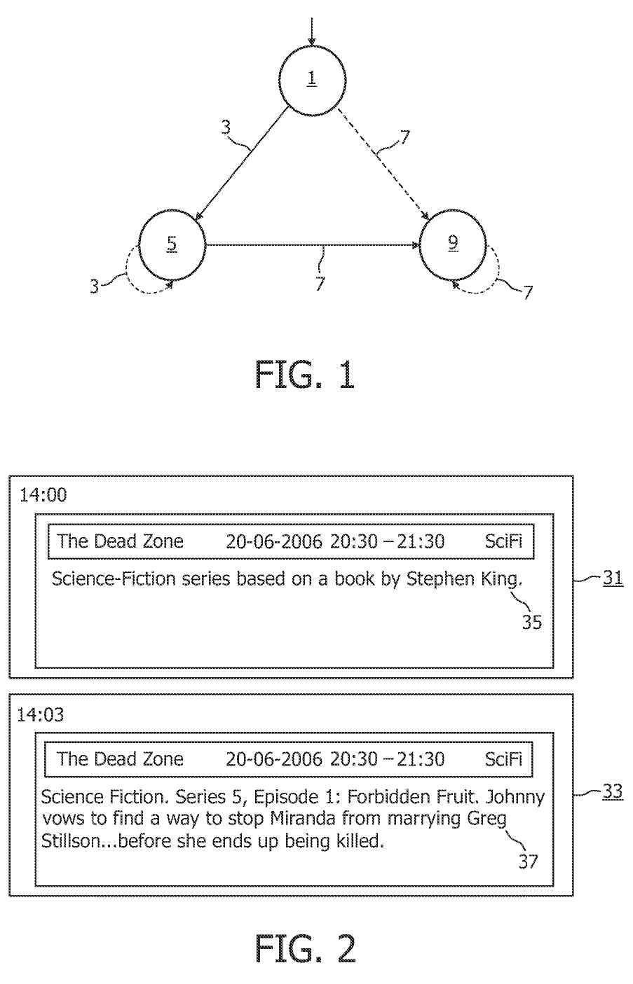

FIG. 1 is a state diagram of the method of the invention;

FIG. 2 shows an example of data displayed by an embodiment of the method of the invention at a first moment and at a second moment; and

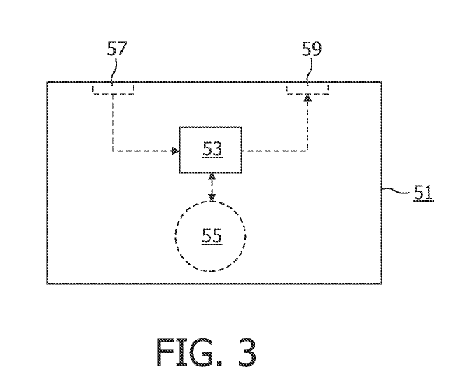

FIG. 3 is a block diagram of the electronic device of the invention.

Corresponding elements in the drawings are denoted by the same reference numerals.

The method of selecting a data item comprises at least four steps. A step 3 comprises receiving a first data item of a first type. A step 5 comprises selecting the first data item. A step 9 comprises selecting a second data item of a second type instead of the first data item of the first type upon receiving the second data item in a step 7 and not selecting the first data item again upon receiving the first data item again. The method of the invention is depicted as a state diagram in FIG. 1. State 1 is the initialization state. Steps 5 and 9 are depicted as states. Steps 3 and 7 are depicted as inputs. If the second data item has not yet been selected (states 1 and 5), the second data item is selected in state 9 when the second data item is received (input 7). If the second data item has already been selected (state 9), it may optionally be re-selected when the second data item is received again. If the first item has not yet been selected, the first data item is only selected (state 5) when the second data item has not yet been selected (i.e. when state 9 has not been reached), i.e. before the first or the second item has been received (state 1) or optionally before the second data item has been received and after the first data item has been received (state 5).

FIG. 2 shows an example of two info areas of the same television program at different moments. The info area 31 shows data selected before the second data item was received, i.e. at 14:00. The info area 33 shows data selected after the second data item was received, i.e. at 14:03. In info area 31, a short program description 35 is shown. In info area 33, the short program description 35 is replaced by a long program description 37. This replacement may be performed while the info area is being displayed or the next time the same info is being requested by the user.

The electronic device 51 comprises electronic circuitry 53, see FIG. 3. The electronic circuitry 53 is configured to receive a first data item of a first type and select the first data item. The electronic circuitry 53 is further configured to select a second data item of a second type instead of the first data item of the first type upon receiving the second data item and not select the first data item again upon receiving the first data item again. The electronic device 51 may be a television, a PC, a game console, an optical disc recorder, a satellite receiver, a terrestrial receiver or a cable receiver, for example. The electronic circuitry 53 may be capable of executing a computer program. The electronic circuitry 53 may be an application-specific processor, as used in many DVD recorders, or a general-purpose processor, as used in many Media Center PCs.

The electronic device 51 may comprise a storage means 55, an input 57 and an output 59. The storage means 55 may comprise an optical disc reader/writer, a magnetic storage means, a solid-state memory, and/or a holographic storage means, for example. The input 57 and output 59 may comprise, for example, a network connector, e.g. a USB connecter or an Ethernet connector, an analogue audio and/or video connector, such as a coaxial connector, a cinch connector or a SCART connector, or a digital audio and/or video connector, such as an HDMI or SPDIF connector. The input 57 can be used to receive the data items, e.g. from VBI data in an analogue channel, from DVB-SI data in a digital channel or from the Internet. The input 57 and output 59 may comprise a wireless receiver and/or transmitter. The electronic device 51 may comprise a reproduction means (not shown). The reproduction means may comprise, for example, a display and/or a loud speaker.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. ‘Computer program product’ is to be understood to mean any software product stored on a computer-readable medium, such as a floppy disk, downloadable via a network, such as the Internet, or marketable in any other manner.

1. An electronic device (51) comprising electronic circuitry (53), the electronic circuitry (53) being configured to:
receive a first data item (35) of a first type;
select the first data item (35); and
select a second data item (37) of a second type instead of the first data item (35) of the first type upon receiving the second data item (37) and not select the first data item (35) again upon receiving the first data item (35) again.

2. An electronic device as claimed in claim 1, wherein the electronic circuitry (53) is configured to parse documents, the first type corresponding to a first document tag and the second type corresponding to a second document tag.

3. An electronic device as claimed in claim 1, wherein the electronic circuitry (53) is configured to repeatedly receive the first data item (35) at a first interval and receive the second data item (37) at a second interval, the second interval being longer than the first interval.

4. An electronic device as claimed in claim 1, wherein the electronic circuitry (53) is configured to first display the first data item (35) of the first type and display the second data item (37) instead of the already displayed first data item (35) upon reception of the second data item (37).

5. An electronic device as claimed in claim 1, wherein the first type and the second type can be defined by a user.

6. An electronic device as claimed in claim 1, wherein the first type represents a short description and the second type represents a long description.

7. An electronic device as claimed in claim 6, wherein the short description and the long description describe a broadcast program.

8. A method of selecting a data item, comprising the steps of:
receiving (3) a first data item of a first type;
selecting (5) the first data item; and
selecting (9) a second data item of a second type instead of the first data item of the first type upon receiving (7) the second data item and not selecting the first data item again upon receiving the first data item again.

9. A computer program product comprising software for enabling a programmable device to perform the method of claim 8.
